(19) United States
(12) Patent Application Publication
(10) Pub. No.: US 2011/0167787 A1
(43) Pub. Date: Jul. 14, 2011

(54) PULSE JET ENGINE

(75) Inventor: H. Brooks Herndon, Lawrence, KS (US)

(73) Assignee: Herndon Development LLC, Lawrence, KS (US)

(21) Appl. No.: 13/001,559

(22) PCT Filed: Jun. 26, 2009
(86) PCT No.: PCT/US09/48785

§ 371 Date: Mar. 23, 2011

Related U.S. Application Data
(60) Provisional application No. 61/076,420, filed on Jun. 27, 2008.

(51) Int. Cl. F02K 7/04

(52) U.S. Cl. 60/204; 60/247

(57) ABSTRACT

The present invention relates to pulse jet engines. More specifically, the present invention concerns a pulse jet engine which uses fluidic valving rather than unreliable mechanical valves, incorporates two combustion chambers with approximately the same but approximately 180 degree out-of-phase resonance frequencies to reduce noise through destructive interference of sound waves, and controls fuel injection and ignition within the two combustion chambers to increase efficiency by achieving more rapid and complete combustion.

### FIELD OF THE INVENTION

The present invention relates to pulse jet engines. More specifically, the present invention concerns a pulse jet engine which uses fluidic valving rather than unreliable mechanical valves, incorporates two combustion chambers with approximately the same but approximately 180 degree out-of-phase resonance frequencies to reduce noise through destructive interference of sound waves, and controls fuel injection and ignition within the two combustion chambers to increase efficiency by achieving more rapid and complete combustion.

### BACKGROUND OF THE INVENTION

Pulse jet engines, or “pulsejets”, are a simple form of internal combustion engine in which combustion occurs in pulses and produces a propulsive exhaust jet. A typical pulse jet engine comprises an air intake fitted with a one-way valve, a combustion chamber, and an exhaust pipe. Air moves into the combustion chamber via the valve, fuel is injected into the combustion chamber and ignited, and the resulting gases are directed rearward via the exhaust pipe. The exhaust pipe has a natural resonance frequency, and the engine, including operation of the valve and ignition of the fuel, is made to operate at this frequency.

Pulse jet engines enjoy the advantages of simple construction and operation and low construction cost. Furthermore, they have no internal momentum to overcome, in the form of, e.g., rotating pistons or fans, so they have a quicker performance response than other types of engines. Unfortunately, pulse jet engines experience frequent valve burn-out, high noise levels, and poor efficiency.

### SUMMARY OF THE INVENTION

The present invention provides an improved pulse jet engine, which overcomes or avoids many of the limitations of conventional pulse jet engines.

In one embodiment, the pulse jet engine broadly comprises fluidic valving operable to control substantially all air flow through the pulse jet engine; first and second combustion chambers with approximately the same but approximately 180 degree out-of-phase resonance frequencies; and a control mechanism to inject and ignite fuel at an approximately maximum pressure within each of the first and second combustion chambers.

In one possible implementation, the pulse jet engine broadly comprises a first vortex generator located within an incoming air flow, and operable to cause a first portion of the incoming air flow to flow around a first side of the first vortex generator and to cause a second portion of the incoming air flow to flow around a second side of the first vortex generator in the manner of an alternating von Karman vortex street; a first combustion chamber located downstream of the first side of the first vortex generator, the first combustion chamber including a first intake port opening substantially tangentially into the first combustion chamber, and a first exhaust port exiting substantially tangentially out of the first combustion chamber; a first exhaust conduit connected to the first exhaust port and operable to direct first exhaust gases rearwardly; a first injector/igniter assembly associated with the first combustion chamber and operable both to introduce and ignite fuel therein; a second combustion chamber located downstream of the second side of the first vortex generator, the first combustion chamber including a second intake port opening substantially tangentially into the second combustion chamber, and a second exhaust port exiting substantially tangentially out of the second combustion chamber; a second exhaust conduit connected to the second exhaust port and operable to direct second exhaust gases rearwardly; a second injector/igniter assembly associated with the second combustion chamber and operable both to introduce and ignite fuel therein; a bypass conduit extending between the first and second combustion chambers and the first and second exhaust conduits, and operable to direct a part of the portion of the air flow rearward; and a second vortex generator is located within the air flow through the bypass conduit, substantially proximate to the ends of the first and second exhaust conduits, and operable to cause a first portion of the bypass air flow to flow around a first side of the second vortex generator and to cause a second portion of the bypass air flow to flow around a second side of the second vortex generator in the manner of an alternating von Karman vortex street.

Implementations of the pulse jet engine may further include any one or more of the following features. The first portion of the air flow flowing around the first side of the first vortex generator, and a first part of the second portion of the air flowing around the second side of the first vortex generator, may be made to enter the first combustion chamber via the first intake port and circulate therein, and a second part of the second portion of the air flowing around the second side of the first vortex generator made be made to enter and flow through the bypass conduit, wherein the first injector/igniter assembly may deliver and ignite fuel within the first combustion chamber to create a first exhaust gas flow, a first part of the first exhaust gas flow may be made to exit the first combustion chamber via the first intake port to cause the air flow around the first vortex generator to switch, the second portion of the air flowing around the second side of the first vortex generator, and a first part of the first portion of the air flowing around the first side of the first vortex generator, may be made to enter the second combustion chamber via the second intake port and circulate therein, a second part of the first portion of the air flowing around the first side of the first vortex generator may be made to enter and flow through the bypass conduit, and a second part of the first exhaust gas flow may be made to exit the first combustion chamber via the first exhaust port, travel through the first exhaust conduit, and cause the second part of the second portion of the air flowing through the bypass conduit to enter the second exhaust conduit and travel there through into the second combustion chamber via the second exhaust port, and wherein the second injector/igniter assembly may deliver and ignite fuel within the second combustion chamber creating a second exhaust gas flow, the first part of the second exhaust gas flow may be made to exit the second combustion chamber via the second intake port to cause the air flow around the first vortex generator to switch, the first portion of the air flowing around the first side of the first vortex generator, and a first part of the second portion of the air flowing around the second side of the first vortex generator, may be made to enter the first combustion chamber via the first intake port and circulate therein, a second part of the second portion of the air flowing around the second side of the first vortex generator may be made to enter and flow through the bypass conduit, and a second part of the second exhaust gas flow may be made to exit the second combustion chamber via the second exhaust port, travel through the second exhaust conduit, and cause the second part o the second portion of the air flowing through the bypass conduit to enter the first exhaust conduit and travel there through into the first combustion chamber via the first exhaust port.

The first and second vortex generators may be substantially circular in cross-sectional shape. The first and second combustion chambers may be substantially circular in cross-sectional shape. The first and second injector/igniter assemblies may be each located in the approximate center of their respective first and second combustion chambers. The first and second injector/igniter assemblies may each include a fuel delivery conduit—operable to receive fuel from a reservoir and disperse it into the combustion chamber; and one or more electrical igniters operable to ignite the fuel. The fuel delivery conduit may include one or more perforations, wherein fuel is injected into the conduit and dispersed into the combustion chamber via the perforations. The fuel delivery conduit may be substantially surrounded by a ceramic sleeve, which supports the one or more electrical igniters fuel delivery conduit. The injector/igniter assembly may be operable to determine and control conditions within the combustion chamber, wherein a reverse electrical voltage is maintained on the electrical igniters at all times except during ignition, which facilitates determining ionization conditions in the combustion chamber and controlling such factors as chamber pressure and ignition timing. The injector/igniter assembly may be controlled by a microcontroller to control the nature of the injected fuel charge and the ignition thereof. The microcontroller may cause the injected fuel charge to be relatively lean early in ignition and relatively rich later in ignition. The microcontroller may cause the fuel to be injected when the circulation within the combustion chamber is at a substantially maximum pressure, and cause the fuel to be ignited before the pressure drops significantly. Heat may be recovered from the exhaust gases and used to warm the fuel prior to injection into the first and second combustion chambers. A plurality of such engines may be arranged within one or more housings and used to power a vehicle, with each engine operating substantially independently of the others. The fuel may include alcohol and water.

These and other aspects of the present invention are discussed below in greater detail in the section titled DETAILED DESCRIPTION OF THE INVENTION.

### BRIEF DESCRIPTION OF THE DRAWING FIGURES

The present invention is described herein with reference to the following drawing figures, with greater emphasis being placed on clarity rather than scale:

FIG. 1 is a cross-sectional plan view of an embodiment of the pulse jet engine of the present invention;

FIG. 2 is an elevation view of an injector/igniter assembly component of the engine of FIG. 1;

FIG. 3 is a cross-sectional plan view of the engine of FIG. 1 illustrating initial fuel, air, and exhaust gas flows through the engine;

FIG. 4 is a cross-sectional plan view of the engine of FIG. 1 illustrating operational fuel, air, and exhaust flows through the engine, wherein combustion is occurring in the first combustion chamber;

FIG. 5 is a cross-sectional plan view of the engine of FIG. 1 illustrating operational fuel, air, and exhaust flows through the engine, wherein combustion is occurring in the second combustion chamber; and

FIG. 6 is a cross-sectional front elevation view of a housing containing a plurality of the pulse jet engines of FIGS. 1-5 arranged in a spaced apart relationship.

### DETAILED DESCRIPTION OF THE INVENTION

With reference to the drawing figures, a pulse jet engine 10 is herein described, shown, and otherwise disclosed in accordance with various embodiments, including one or more preferred embodiments, of the present invention.

Broadly, the pulse jet engine 10 uses fluidic valving rather than unreliable mechanical valves, incorporates two combustion chambers with approximately the same but approximately 180 degree out-of-phase resonance frequencies to reduce noise through destructive interference of sound waves, and controls fuel injection and ignition within the two combustion chambers to increase efficiency by achieving more rapid and complete combustion.

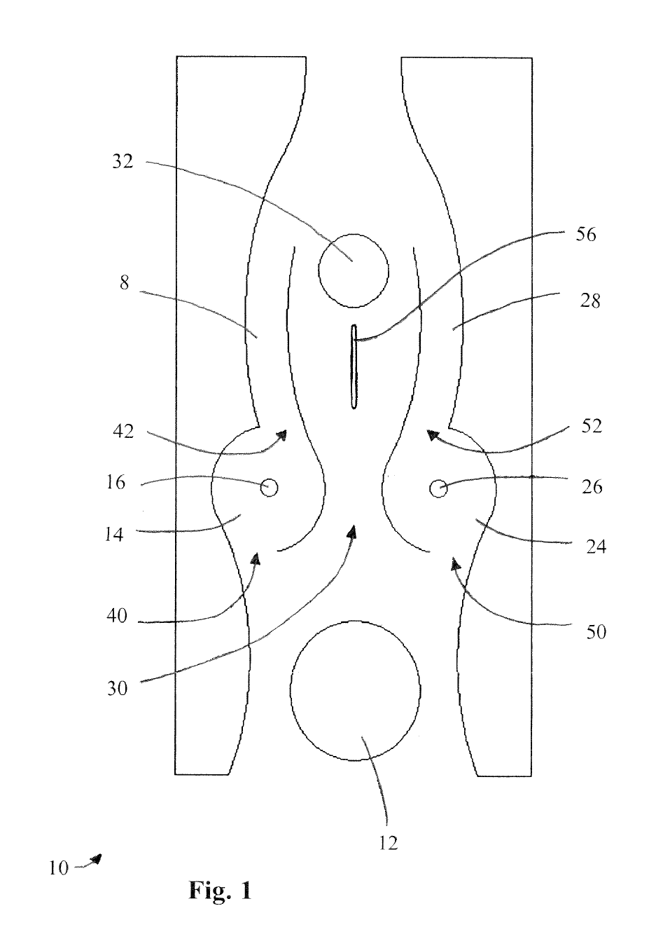

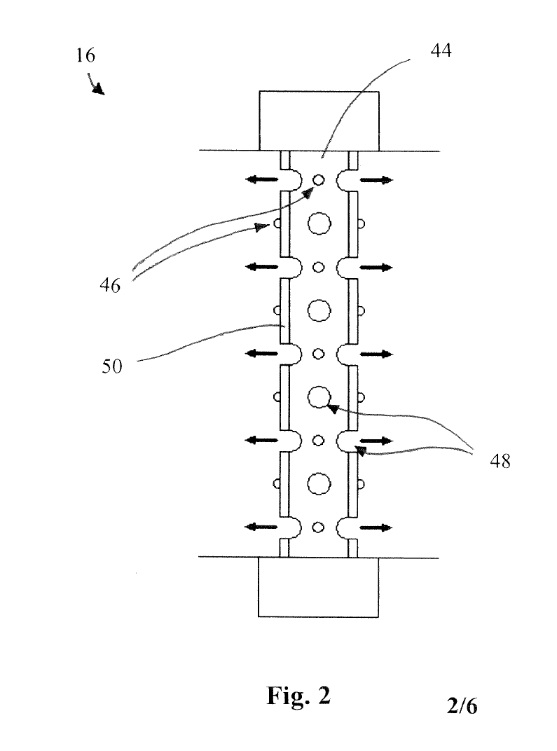

Referring to FIGS. 1 and 2, the engine 10 broadly comprises a first vortex generator 12; a first combustion chamber 14 associated with a first injector/igniter assembly 16 and connected to and in fluid communication with a first exhaust conduit 18; a second combustion chamber 24 associated with a second injector/igniter assembly 26 and connected to and in fluid communication with a second exhaust conduit 28; a bypass conduit 30; and a second vortex generator 32.

The first vortex generator 12 may be substantially circular in cross-sectional shape, located within the incoming air flow, and operable to cause a first portion of the incoming air to flow around a first side of the first vortex generator 12 and to cause a second portion of the incoming air to flow around a second side of the first vortex generator 12 in such a manner as to cause all of one portion and at least a part of the other portion to alternatingly flow into one and then the other of the two combustion chambers 14,24.

More specifically, the first vortex generator 12 is located within the incoming air flow and is operable to produce a von Karman vortex street, i.e., a generally alternating pattern in the downstream air flow caused by unsteady separation of the air flow around the first vortex generator 12 and the downstream shedding of vortices. Creation of this effect requires a threshold Reynolds number, which is generally a function of the diameter of the first vortex generator 12, the velocity of the upstream air flow, and the viscosity of the air; thus, any actual implementation of the engine 10 will likely consider these factors as they relate to any contemplated application. Lower Reynolds numbers will result only in laminar flow around the first vortex generator 12 and, therefore, somewhat less efficient operation of the engine 10. Furthermore, it may be desirable to appropriately match the alternations in the downstream airflow with the natural resonance frequency of the engine, so that, as discussed below, the switching of the downstream airflow substantially matches the intake cycles of the combustion chambers 14,24.

The combustion chambers 14,24, injector/igniter assemblies 16,26, and exhaust conduits 18,28 may be structurally and operational (albeit approximately 180 degrees out of phase) substantially identical.

For each side of the engine, the combustion chamber 14,24 is located downstream of the first vortex generator 12, may have a substantially circular cross-sectional shape, and is operable to receive, mix, and compress air and fuel for combustion. The combustion chamber 14,24 may include an intake port 40,50 opening substantially tangentially into the chamber 14,24, such that air entering the substantially circular chamber is made to circulate therewithin, and an exhaust port 42,52 exiting substantially tangentially out of the chamber 14,24. The exhaust conduit 18,28 is connected to the exhaust port 42,52 and is operable to direct the combusted exhaust gases toward the rear of the engine 10.

Referring particularly to FIG. 2, the injector/igniter assembly 16,26 is associated with the combustion chamber 14,24 and operable both to introduce and ignite fuel therein. The assembly 16,26 may be located in the approximate center of the substantially circular chamber 14,24 and may include a fuel delivery conduit 44 operable to receive fuel from a reservoir and disperse it into the chamber 14,24 and at least one electrical igniter 46 operable to ignite the fuel. The fuel delivery conduit 44 may include one or more perforations 48, wherein fuel is injected into the conduit 44 and dispersed into the chamber 14 via the perforations 48. The conduit 44 may be coated with or surrounded by a ceramic sleeve or sheath 50, which supports the one or more electrical igniters 46 in electrical isolation from the fuel conduit 44. In one implementation, a plurality of the perforations 48 and the electrical igniters 46 provide more even fuel distribution and ignition within the chamber 14,24.

In one implementation, the injector/igniter assembly 16,26 may be used as a sensor to determine and control conditions within the combustion chamber 14,24. This may be accomplished by, for example, maintaining a reverse electrical voltage on the electrical igniters 46 except at least during ignition, which facilitates determining ionization conditions in the combustion chamber 14,24 and controlling such factors as chamber pressure and ignition timing.

Relatedly, the injector/igniter assembly 16,26 can be controlled by a microcontroller to control the nature of the injected fuel charge and the ignition thereof. In one implementation, the microcontroller may cause the injected fuel charge to be relatively lean early in ignition and relatively rich later in ignition so that the charge ignites and propagates as desired. In one implementation, the microcontroller may cause the fuel to be injected when the circulation within the combustion chamber 14,24 is at its approximately maximum pressure. More specifically, during operation, the vortices increase speed, stop, and then change direction; the fuel is injected at the moment the vortices stop. Thereafter, before the pressure begins to drop, the fuel is ignited. Thus, rather than sucking fuel into the combustion chamber using low pressure, as is the case with conventional pulse jet engines, the present invention injects fuel into the combustion chamber using high pressure in order to better control the circumstances of ignition.

The bypass conduit 30 extends between the first and second combustion chambers 14,24 and the first and second exhaust conduits 18,28 and is operable to direct a part of the portion of the intake air flow rearward.

In one implementation, a vane 56 is positioned in the bypass conduit upstream of the second vortex generator 32 to at least partially straighten the air flow 10 through the bypass conduit 30.

The second vortex generator 32 is located within the air flow through the bypass conduit 30, proximate to the ends of the first and second exhaust conduits 18,28, and operates, as a general matter, substantially similar to the first vortex generator 12 in that it introduces a generally alternating pattern in the downstream air flow. In one implementation, exhaust gases exiting one of the exhaust conduits 18,28 forces at least a portion of the air flowing through the bypass conduit 30 into the other exhaust conduit 28,18 and, therefrom, into the other combustion chamber 24,14 thereby introducing fresh air into the other combustion chamber 24,14 through both the intake port 50,40 and the exhaust port 52,42. In one implementation, exhaust gases exiting the exhaust conduits 18,28 create low pressure, which helps to draw air into the bypass conduit 30, which facilitates proper operation of the fluidic intake valve created by the first vortex generator 12.

Because the first and second combustion chambers 14,24 are operated out-of-phase with each other, the exhaust of one can be used to control the operation of the other, in the manner of a fluidic valve. In one implementation, the engine 10, or at least the portions thereof discussed herein, may have relatively few or even no moving parts.

In one implementation, heat may be recovered from the exhaust gases and used to warm the fuel, thereby increasing combustion efficiency. This may be 30 accomplished, for example, by providing a conduit wrapped around or otherwise in contact with the housing of the engine 10, and directing the fuel through the conduit prior to use, such that heat from the housing is transferred to the fuel via the conduit.

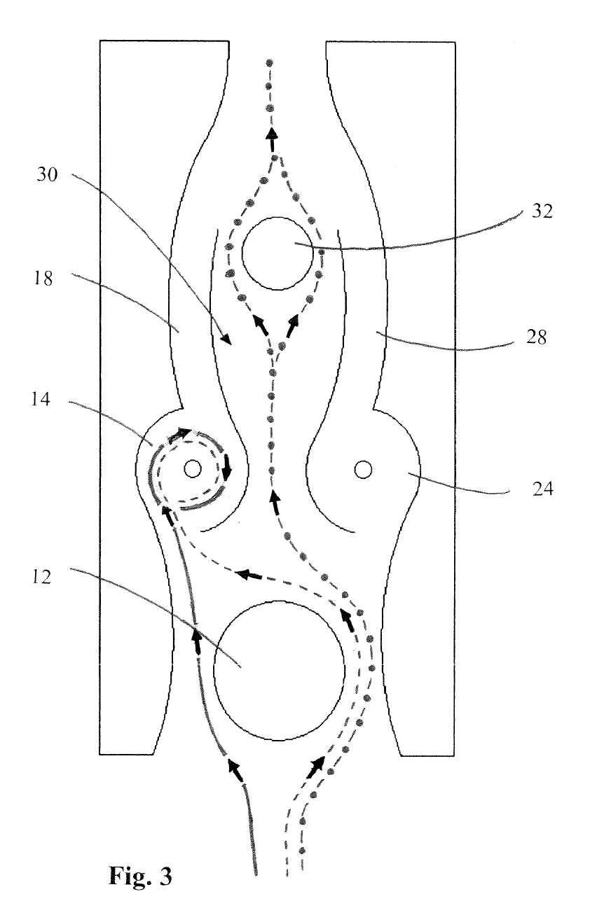

In exemplary operation, the engine 10 may function substantially as follows. Initially, as shown in FIG. 3, the first portion (which is shown with a solid line) of the air flow flowing around the first side of the first vortex generator 12, and a first part (which is shown with a dashed line) of the second portion of the air flowing around the second side of the first vortex generator 12, enter the first combustion chamber 14 via the first intake port 40 and circulate therein. A second part (Which is shown with a dash-dot line) of the second portion of the air flowing around the second side of the vortex generator enters and flows through the bypass conduit 30.

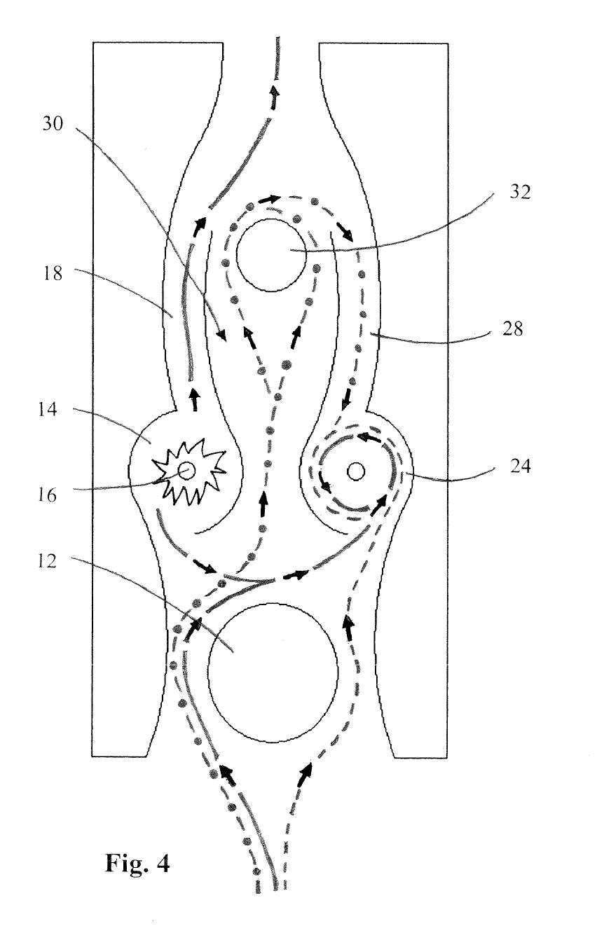

As shown in FIG. 4, the first injector/igniter assembly 16 delivers and ignites fuel within the first combustion chamber 14 creating a first exhaust gas flow. A first part (which is shown with a solid line) of the first exhaust gas flow exits the first combustion chamber 14 via the first intake port 40 to prompt the air flow around the first vortex generator 12 to switch. As a result, the second portion (which is shown with a dashed line) of the air flowing around the second side of the first vortex generator 12, and a first part (which is shown with a solid line) of the first portion of the air flowing around the first side of the first vortex generator 12, enters the second combustion chamber 24 via the second intake port 50 and circulates therein. A second part (which is shown with a dash-dot line) of the first portion of the air flowing around the first side of the first vortex generator 12 enters and flows through the bypass conduit 30. A second part (which is shown with a solid line) of the first exhaust gas flow exits the first combustion chamber 14 via the first exhaust port 42, travels through the first exhaust conduit 18, and causes the second part (which is shown with a dash-dot line) of the second portion of the air flowing through the bypass conduit 30 to enter the second exhaust conduit 28 in an upstream direction and travel therethrough into the second combustion chamber 24 via the second exhaust port 52.

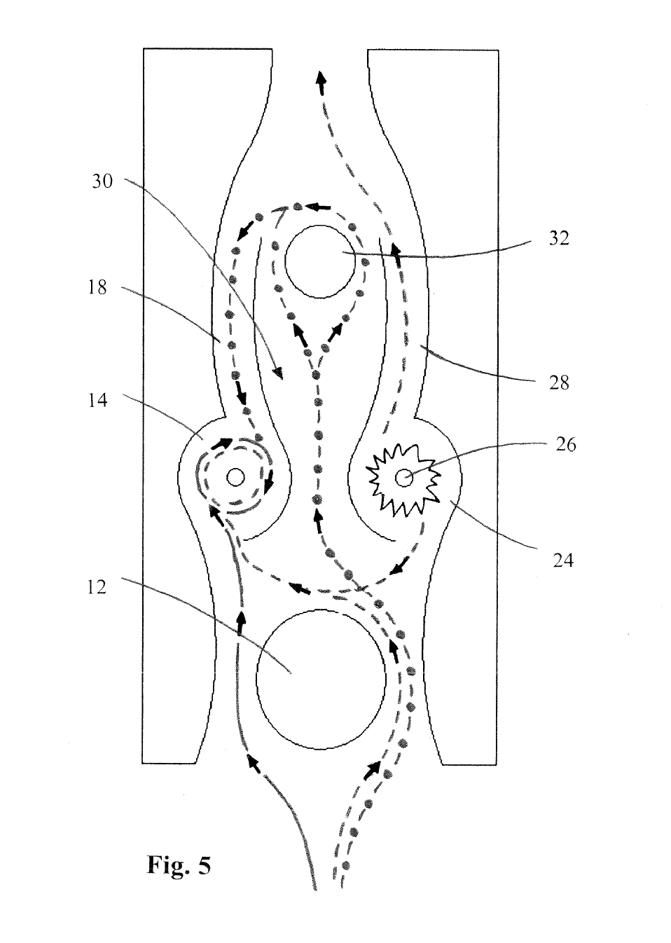

As shown in FIG. 5, the second injector/igniter assembly 26 delivers and ignites fuel within the second combustion chamber 24 creating a second exhaust gas flow. A first part (which is shown with a dashed line) of the second exhaust gas flow exits the second combustion chamber 24 via the second intake port 50 to prompt the air flow around the first vortex generator 12 to switch. As a result, the first portion (which is shown with a solid line) of the air flowing around the first side of the first vortex generator 12, and a first part (which is shown with a dashed line) of the second portion of the air flowing around the second side of the first vortex generator 12, enters the first combustion chamber 14 via the first intake port 40 and circulates therein. A second part (which is shown with a dash-dot line) of the second portion of the air flowing around the second side of the first vortex generator 12 enters and flows through the bypass conduit 30. A second part (which is shown with a dashed line) of the second exhaust gas flow exits the second combustion chamber 24 via the second exhaust port 52, travels through the second exhaust conduit 28, and causes the second part (which is shown with a dash-dot line) of the second portion of the air flowing through the bypass conduit 30 to enter the first exhaust conduit 18 and travel there through in an upstream direction into the first combustion chamber 14 via the first exhaust port 42.

Thereafter, the processes of FIGS. 4 and 5 continue to occur in an alternating manner until the engine is stopped.

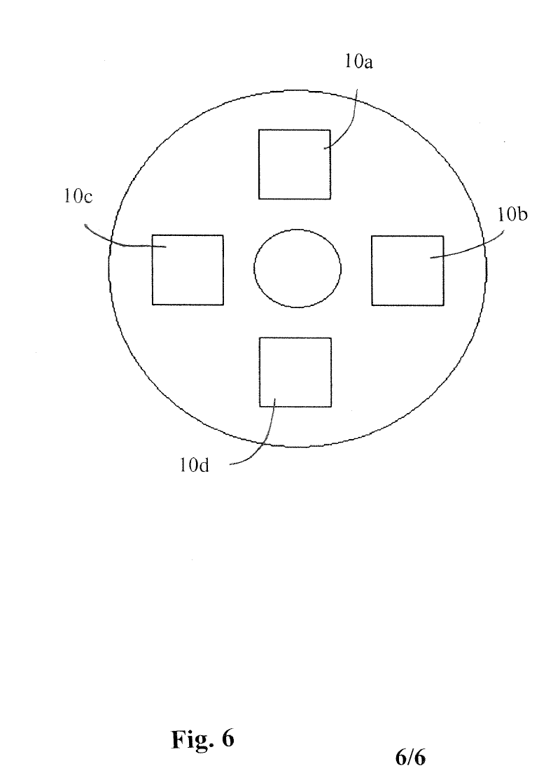

In one implementation, the engine may have a substantially square or rectangular lateral cross-sectional shape, be approximately between 5 inches and 8 inches in width and approximately between 24 inches and 36 inches in length, and generate approximately between 275 pounds of thrust and 325 pounds of thrust. As shown in FIG. 6, a plurality of such engines 10a,10b,10c,10d may be arranged within one or more housings and used to power a vehicle such as an aircraft, with each engine operating substantially independently of the others.

In one application, the engine may be fueled by a relatively clean fuel, such as alcohol and water, which results in relatively little or no carbon or other undesirable deposits.

From the foregoing, it will be appreciated that the present engine retains the advantages of simplicity of construction and operation and low construction cost, while overcoming the disadvantages of prior art engines.

Although the invention has been disclosed with reference to various particular embodiments and implementations, it is understood that equivalents may be employed and substitutions made herein without departing from the scope of the invention.

1. A pulse jet engine comprising:
fluidic valving operable to control substantially all air flow through the pulse jet engine; first and second combustion chambers with approximately the same but approximately
180 degree out-of-phase resonance frequencies; and
a control mechanism to inject and ignite fuel at an approximately maximum pressure within each of the first and second combustion chambers.

2. The pulse jet engine as set forth in 1, above, wherein exhaust gases produced by each combustion chamber are at least a component of the fluidic valving.

3. A pulse jet engine comprising:
a first vortex generator located within an incoming air flow, and operable to cause a first portion of the incoming air flow to flow around a first side of the first vortex generator and to cause a second portion of the incoming air flow to flow around a second side of the first vortex generator in the manner of an alternating von Karman vortex street;
a first combustion chamber located downstream of the first side of the first vortex generator, the first combustion chamber including
a first intake port opening substantially tangentially into the first combustion chamber, and
a first exhaust port exiting substantially tangentially out of the first combustion chamber;
a first exhaust conduit connected to the first exhaust port and operable to direct first exhaust gases rearwardly;
a first injector/igniter assembly associated with the first combustion chamber and operable both to introduce and ignite fuel therein;
a second combustion chamber located downstream of the second side of the first vortex generator, the first combustion chamber including
a second intake port opening substantially tangentially into the second combustion chamber, and
a second exhaust port exiting substantially tangentially out of the second combustion chamber;
a second exhaust conduit connected to the second exhaust port and operable to direct second exhaust gases rearwardly;
a second injector/igniter assembly associated with the second combustion chamber and operable both to introduce and ignite fuel therein;
a bypass conduit extending between the first and second combustion chambers and the first and second exhaust conduits, and operable to direct a part of the portion of the air flow rearward; and
a second vortex generator is located within the air flow through the bypass conduit, substantially proximate to the ends of the first and second exhaust conduits, and operable to cause a first portion of the bypass air flow to flow around a first side of the second vortex generator and to cause a second portion of the bypass air flow to flow around a second side of the second vortex generator in the manner of an alternating von Karman vortex street.

4. The pulse jet engine as set forth in 3, above,
wherein
the first portion of the air flow flowing around the first side of the first vortex generator, and a first part of the second portion of the air flowing around the second side of the first vortex generator, enters the first combustion chamber via the first intake port and circulates therein, and
a second part of the second portion of the air flowing around the second side of the first vortex generator enters and flows through the bypass conduit, wherein-
the first injector/igniter assembly delivers and ignites fuel within the first combustion chamber to create a first exhaust gas flow,
a first part of the first exhaust gas flow exits the first combustion chamber via the first intake port to cause the air flow around the first vortex generator to switch,
the second portion of the air flowing around the second side of the first vortex generator, and a first part of the first portion of the air flowing around the first side of the first vortex generator, enters the second combustion chamber via the second intake port and circulates therein,
a second part of the first portion of the air flowing around the first side of the first vortex generator enters and flows through the bypass conduit, and
a second part of the first exhaust gas flow exits the first combustion chamber via the first exhaust port, travels through the first exhaust conduit, and causes the second part of the second portion of the air flowing through the bypass conduit to enter the second exhaust conduit and travel there through into the second combustion chamber via the second exhaust port, and
wherein-
the second injector/igniter assembly delivers and ignites fuel within the second combustion chamber creating a second exhaust gas flow,
the first part of the second exhaust gas flow exits the second combustion chamber via the second intake port to cause the air flow around the first vortex generator to switch,
the first portion of the air flowing around the first side of the first vortex generator, and a first part of the second portion of the air flowing around the second side of the first vortex generator, enters the first combustion chamber via the first intake port and circulates therein,
a second part of the second portion of the air flowing around the second side of the first vortex generator enters and flows through the bypass conduit, and
a second part of the second exhaust gas flow exits the second combustion chamber via the second exhaust port, travels through the second exhaust conduit, and causes the second part of the second portion of the air flowing through the bypass conduit to enter the first exhaust conduit and travel therethrough into the first combustion chamber via the first exhaust port.

5. The pulse jet engine as set forth in 3, above, wherein the first and second vortex generators are substantially circular in cross-sectional shape.

6. The pulse jet engine as set forth in 3, above, wherein the first and second combustion chambers are substantially circular in cross-sectional shape.

7. The pulse jet engine as set forth in 3, above, wherein the first and second injector/igniter assemblies are each located in the approximate center of their respective first and second combustion chambers.

8. The pulse jet engine as set forth in 3, above, wherein the first and second injector/igniter assemblies each includes—
a fuel delivery conduit operable to receive fuel from a reservoir and disperse it into the combustion chamber; and
one or more electrical igniters operable to ignite the fuel.

9. The pulse jet engine as set forth in 8, above, wherein the fuel delivery conduit includes one or more perforations, wherein fuel is injected into the conduit and dispersed into the combustion chamber via the perforations.

10. The pulse jet engine as set forth in 8, above, wherein the fuel delivery conduit is substantially surrounded by a ceramic sleeve which supports the one or more electrical igniters on the fuel delivery conduit.

11. The pulse jet engine as set forth in 8, above, wherein the injector/igniter assembly is operable to determine and control conditions within the combustion chamber, wherein a reverse electrical voltage is maintained on the electrical igniters except at least during ignition, which facilitates determining ionization conditions in the combustion chamber and controlling such factors as chamber pressure and ignition timing.

12. The pulse jet engine as set forth in 8, above, wherein the injector/igniter assembly is controlled by a microcontroller to control the nature of the injected fuel charge and the ignition thereof.

13. The pulse jet engine as set forth in 12, above, wherein the microcontroller causes the injected fuel charge to be relatively lean early in ignition and relatively rich later in ignition.

14. The pulse jet engine as set forth in 12, above, wherein the microcontroller causes the fuel to be injected when the circulation within the combustion chamber is at a substantially maximum pressure, and causes the fuel to be ignited before the pressure drops significantly.

15. The pulse jet engine as set forth in 3, above, wherein heat is recovered from the exhaust gases and used to warm the fuel prior to injection into the first and second combustion chambers.

16. The pulse jet engine as set forth in 3, above, wherein a plurality of such engines are arranged within one or more housings and used to power a vehicle, with each engine operating substantially independently of the others.

17. The pulse jet engine as set forth in 3, above, wherein the fuel includes alcohol and water.

18. A method of operating a pulse jet engine, the method comprising the steps of:
diverting a first portion of an air flow, and a first part of a second portion of the air flow into a first combustion chamber via a first intake port so as to circulate therein;
diverting a second part of the second portion of the air flow into a bypass conduit;
delivering and igniting fuel within the first combustion chamber to create a first exhaust gas flow, wherein—
a first part of the first exhaust gas flow exits the first combustion chamber via the first intake port, thereby—
diverting the second portion of the air flow, and a first part of the first portion of the air flow, into a second combustion chamber via a second intake port so as to circulate therein, and
diverting a second part of the first portion of the air flow into the bypass conduit, and
a second part of the first exhaust gas flow exits the first combustion chamber via a first exhaust port, travels through a first exhaust conduit, and causes the second part of the second portion of the air flow flowing through the bypass conduit to enter a second exhaust conduit and travel therethrough into the second combustion chamber via a second exhaust port;
delivering and igniting fuel within the second combustion chamber to create a second exhaust gas flow, wherein—
a first part of the second exhaust gas flow exits the second combustion chamber via the second intake port, thereby
diverting the first portion of the air flow, and a first part of the second portion of the air flow, into a first combustion chamber via a first intake ort so as to circulate therein, and
diverting a second part of the second portion of the air flow into the bypass conduit, and
a second part of the second exhaust gas flow exits the second combustion chamber via a second exhaust port, travels through a second exhaust conduit, and causes the second part of the first portion of the air flow flowing through the bypass conduit to enter the first exhaust conduit and travel therethrough into the first combustion chamber via the first port.
